(19) United States
(12) Patent Application Publication
(10) Pub. No.: US 2014/0139202 A1
(43) Pub. Date: May 22, 2014

(54) ENHANCED LEAKAGE COMMON MODE INDUCTOR

(71) Applicant: Adam Michael White, Belvidere, IL (US)

(72) Inventor: Adam Michael White, Belvidere, IL (US)

(21) Appl. No.: 13/682,795

(22) Filed: Nov. 21, 2012

(51) Int. Cl. H01F 27/24; H01F 41/00; H01F 38/00

(52) U.S. Cl. CPC H01F 27/24; H01F 38/00; H01F 41/00
USPC 323/355; 336/214; 29/602.1

(57) ABSTRACT

In some embodiments, a common mode inductor comprises a principal core, and a leakage boosting core located within a threshold distance of the principal core in order to enhance a leakage flux of the inductor. In some embodiments, a circuit comprises a power converter, and a common mode inductor coupled to the power converter, the common mode inductor comprising a principal core and a leakage boosting core located within a threshold distance of the principal core wherein the threshold distance is selected to control a leakage flux of the inductor.

### BACKGROUND

Electro-magnetic interference (EMI) and power quality requirements frequently create a need for filtering incoming and/or outgoing power from a power converter. This filtering is commonly accomplished using networks of capacitors and inductors. Separate filtering circuits are designed for filtering common mode and differential mode distortion of the power converter. The common mode filter circuit employs a common mode inductor, and the differential mode circuit employs differential mode inductors for each line being filtered.

In order to filter common mode distortions a common mode inductor may be used. An example of such an inductor 100 is shown in FIG. 1. The inductor 100 may be comprised of windings 102a-102c (shown as dots in FIG. 1), wound on a common core 104, for each line entering or exiting the power converter. The windings 102a-102c may be spatially displaced from one another by one-hundred twenty (120) degrees. Currents common to all lines may cause a flux, shown via a common mode flux path 106, which couples all three windings 102a-102c. This flux 106, coupling all the windings 102a-102c, is what contributes to the common mode inductance of a power converter circuit.

Additionally, there will be some flux that leaves the core and does not couple all the windings 102a-102c. This component of the flux, known as a leakage flux and shown in FIG. 2 via leakage flux paths 202, contributes to the differential mode inductance of the power converter circuit. The leakage inductance of the common mode reduces the additional differential mode inductance that must be supplied by differential mode inductors in the power converter circuit, and thereby can reduce the size and weight of the power converter differential mode inductors. However, the leakage inductance is typically small, such that substantial additional differential mode inductance is still required.

### BRIEF SUMMARY

In some embodiments, a common mode inductor comprises a principal core, and a leakage boosting core located within a threshold distance of the principal core in order to enhance a leakage flux of the inductor.

In some embodiments, a circuit comprises a power converter, and a common mode inductor coupled to the power converter, the common mode inductor comprising a principal core and a leakage boosting core located within a threshold distance of the principal core wherein the threshold distance is selected to control a leakage flux of the inductor.

In some embodiments, a method for reducing the use of differential mode inductors in a power converter circuit comprises constructing a common mode inductor comprising a principal core and a leakage boosting core located within a threshold distance of the principal core, and causing the inductor to be coupled to at least one of an input of a power converter and an output of the power converter.

Additional embodiments are described below.

### BRIEF DESCRIPTION OF THE DRAWINGS

The present disclosure is illustrated by way of example and not limited in the accompanying Figures, in which:

FIG. 1 illustrates a common mode inductor and a common mode flux path in accordance with the prior art;

FIG. 2 illustrates a common mode inductor and leakage flux paths in accordance with the prior art;

FIG. 3 illustrates an exemplary leakage-boosting ferromagnetic core in conjunction with a principal common mode core in accordance with one or more aspects of this disclosure;

FIG. 4 illustrates an exemplary leakage-boosting ferromagnetic core in conjunction with a principal common mode core in accordance with one or more aspects of this disclosure;

FIG. 5 illustrates exemplary leakage-boosting ferromagnetic cores in conjunction with a principal common mode core in accordance with one or more aspects of this disclosure;

FIG. 6 illustrates a block diagram of a power converter circuit in accordance with one or more embodiments of this disclosure; and

FIG. 7 illustrates an exemplary method in accordance with one or more embodiments of this disclosure.

### DETAILED DESCRIPTION

In accordance with various embodiments of the disclosure, one or more leakage-boosting cores of may be placed concentric with a principal common mode inductor core and windings. These cores can be, for example, ferromagnetic (e.g., a high permeability magnetic material) and their presence in proximity to the principal common mode inductor assembly may cause additional flux to leave the principal common mode inductor core, thus increasing the leakage inductance of the common mode inductor. As a consequence of the additional differential mode inductance introduced by the leakage-boosting core(s), the need to employ additional differential mode inductors in a power converter circuit may be eliminated or substantially reduced. The amount of leakage inductance may be controlled by varying an air gap between the principal common mode inductor core and the leakage boosting core(s).

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this regard, a coupling of entities, components, and/or devices may refer to either a direct connection or an indirect connection.

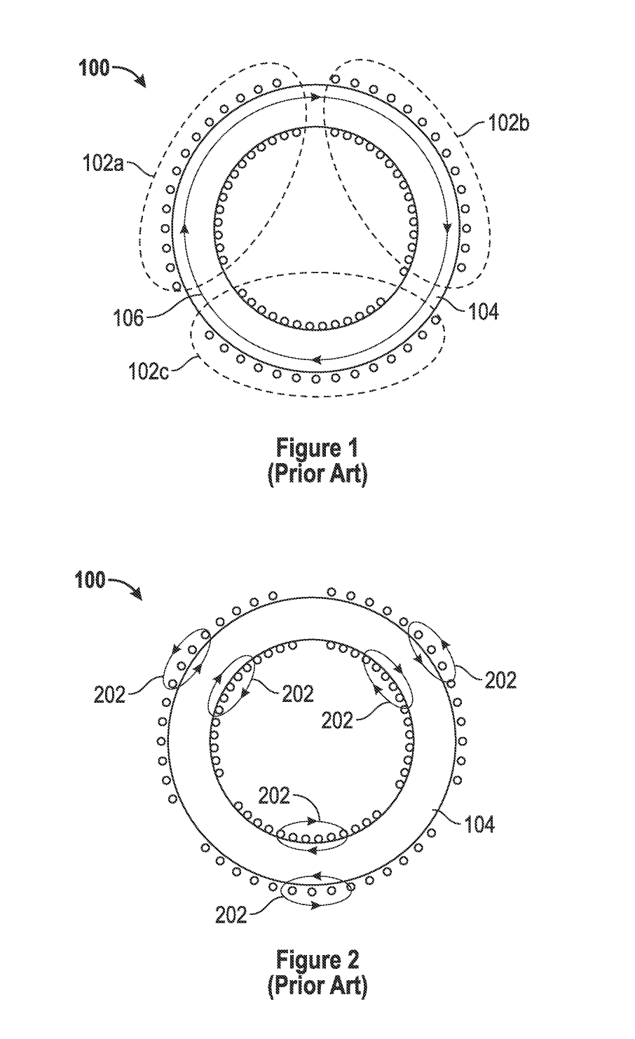

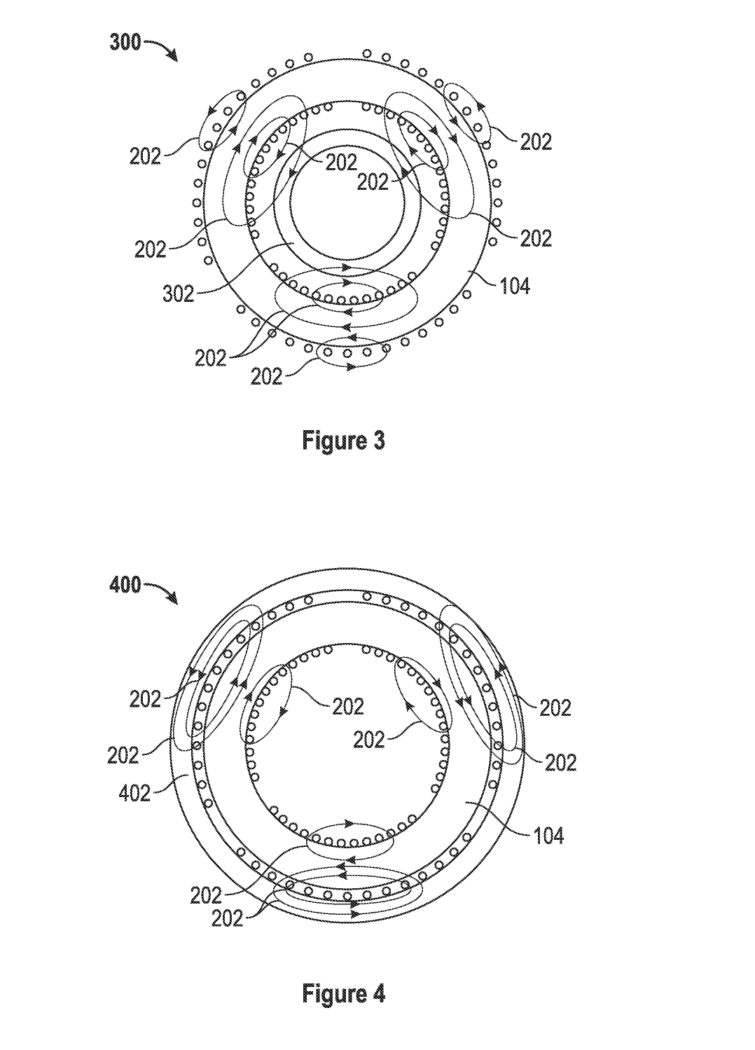

FIG. 3 illustrates a common mode inductor 300 according to one embodiment. The inductor 300 may include a core 302 located within an inner diameter of the (principal) core 104. The core 302 may be composed of a highly permeable ferromagnetic material. Relative to the inductor 100 of FIGS. 1-2, additional leakage flux paths 202 may be present in connection with the inductor 300. The presence of the core 302 in proximity to the core 104 may cause the additional flux to leave the core 104, thereby increasing the leakage inductance of the inductor 300 relative to the inductor 100.

FIG. 4 illustrates another embodiment of a common mode inductor 400. The inductor 400 may include a core 402 located outside an outer diameter of the (principal) core 104. The core 402 may be composed of a highly permeable ferromagnetic material. Relative to the inductor 100 of FIGS. 1-2, additional leakage flux paths 202 may be present in connection with the inductor 400. The presence of the core 402 in proximity to the core 104 may cause the additional flux to leave the core 104, thereby increasing the leakage inductance of the inductor 400 relative to the inductor 100.

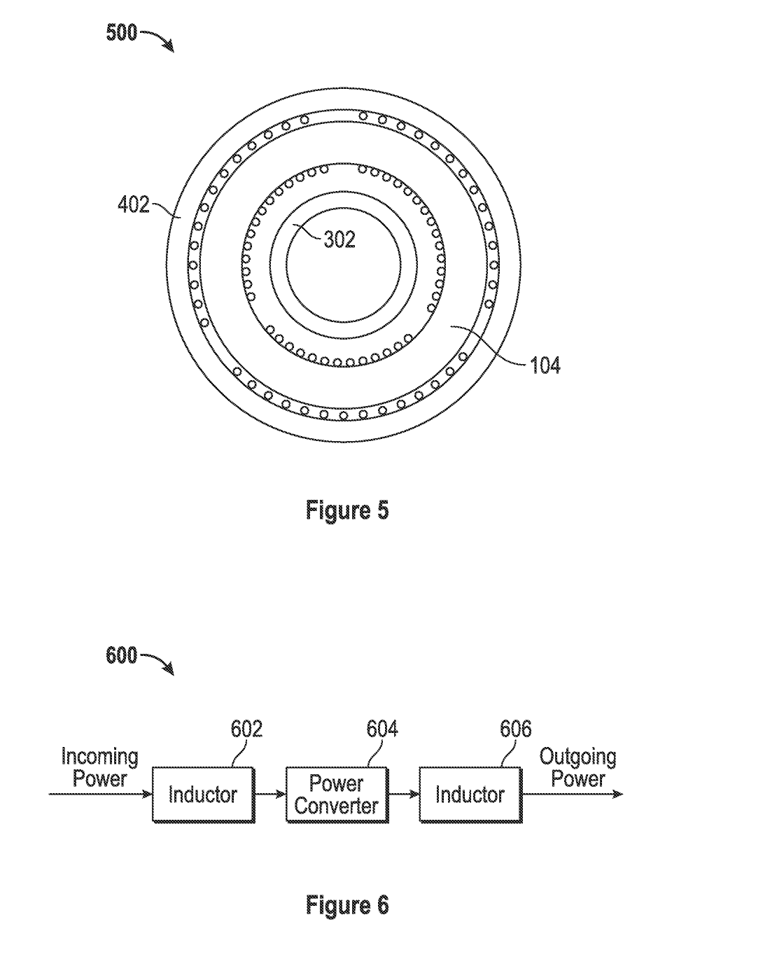

FIG. 5 illustrates a common mode inductor 500. The inductor 500 may include the (principal) core 104, the core 302 located within the inner diameter of the core 104, and the core 402 located outside the outer diameter of the core 104. Thus, the inductor 500 may represent an effective combination of the inductors 300 and 400. While not shown in FIG. 5, additional leakage flux paths (e.g., leakage flux paths 202) may be present in connection with the inductor 500 relative to the inductors 100, 300, and 400.

The embodiment of FIG. 5 illustrates the inclusion or use of two cores 302 and 402 in addition to the (principal) core 104. More generally, any number of cores may be included in some embodiments.

In some embodiments, cores may be arranged relative to one another in any number of ways. For example, the core 302 and/or the core 402 may be located or positioned axially in-line with (e.g., above or below) the core 104.

In some embodiments, separate cores may be combined to form a single part. For example, the core 302, the core 402 and a core axially in line with core 104 may be combined into a single core surrounding the (principal) core 104.

FIG. 6 illustrates a power converter circuit 600 in accordance with one or more embodiments. The circuit 600 may include an inductor 602 that may receive input or incoming power. The inductor 602 may filter the incoming power and provide the filtered power to an input of a power converter 604. An output of the power converter 604 may be provided to an inductor 606. The inductor 606 may filter the power provided to it by the power converter 604 and provide the filtered power as output or outgoing power.

In some embodiments, the power converter 604 may be, or include, a switching power converter. In some embodiments, one or both of the inductors 602 and 606 may be, or include, a common mode inductor. In some embodiments, the inductor 602 may correspond to the inductors 300, 400, or 500. In some embodiments, the inductor 606 may correspond to the inductors 300, 400, or 500.

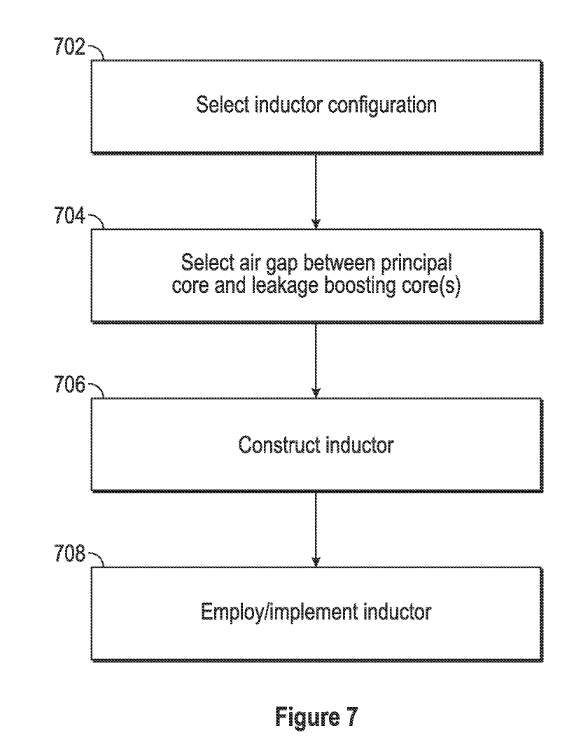

FIG. 7 illustrates a method in accordance with one or more embodiments of the disclosure. The method of FIG. 7 may be executed in order to make and use an inductor. The method of FIG. 7 may be operative in connection with one or more components or devices, such as those described herein. In some embodiments, some or all of the method of FIG. 7 may be executed by a computing device comprising a processor.

In block 702, a configuration for an inductor (e.g., a common mode inductor) may be selected. The selection may include selection of a principal core (e.g., core 104) and one or more leakage boosting cores (e.g., core 302, core 402). The selection of block 702 may be based on one or more inputs, such as environmental conditions, materials available, etc.

In block 704, an air gap between the principal core and the leakage boosting core(s) may be selected. The selection or design variation in the air gap may be used to control an amount of leakage inductance in the inductor.

In block 706, the inductor may be constructed, manufactured, assembled, or fabricated. The construction of block 706 may be based on the selections of blocks 702 and 704. The construction of block 706 may include a placement of windings about the principal core and placement of the leakage boosting core(s) in proximity to the principal core. In some embodiments, one or more leakage boosting cores may include windings. In some embodiments, one or more of the leakage boosting cores may be located or positioned axially in-line with the principal core.

In block 708, the constructed inductor of block 706 may be employed or implemented. For example, in connection with block 708, the constructed inductor of block 706 may be implemented as part of a power converter circuit (e.g., the circuit 600). The inductor may be used to address electro-magnetic interference (EMI) and/or power quality requirements associated with the power converter circuit. The inductor may be used to filter incoming and/out outgoing power from the power converter. The inductor may be used to reduce or eliminate the need to employ differential mode inductors in the power converter circuit.

Embodiments of the disclosure may be tied to particular machines. For example, in some embodiments one or more leakage boosting cores or ferromagnetic material may be employed in proximity to (e.g., in an amount less than a threshold from) a principal core of a common mode inductor in order to enhance the leakage flux of the inductor.

Embodiments of the disclosure may be used in connection with an inverter or rectifier. In some embodiments, an inductor may be used in connection with alternating current (AC) or direct current (DC) power. In some embodiments, an inductor may be used in connection with three-phase power applications. For example, a first set of windings may be used in connection with a first phase, a second set of windings may be used in connection with a second phase, and a third set of windings may be used in connection with a third phase.

In some embodiments various functions or acts may take place at a given location and/or in connection with the operation of one or more apparatuses or systems. In some embodiments, a portion of a given function or act may be performed at a first device or location, and the remainder of the function or act may be performed at one or more additional devices or locations. Embodiments of the disclosure may be directed to one or more systems, apparatuses, and/or methods.

Embodiments of the disclosure may be implemented using hardware, software, firmware, or any combination thereof. In some embodiments, various mechanical components known to those of skill in the art may be utilized.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative Figures may be performed in other than the recited order, and that one or more steps illustrated may be optional in accordance with aspects of the disclosure.

1. A common mode inductor comprising:
a principal core; and
a leakage boosting core separate from the principal core and located within a threshold distance of the principal core in order to enhance a leakage flux of the inductor.

2. The inductor of claim 1, wherein a distance between the principal core and the leakage boosting core defines an air gap between the principal core and the leakage boosting core the size of which controls an amount of leakage inductance in the inductor.

3. The inductor of claim 1, wherein the leakage boosting core is located within an inner diameter of the principal core.

4. The inductor of claim 3, further comprising:
a second leakage boosting core located within a second threshold distance of the principal core in order to enhance the leakage flux of the inductor.

5. The inductor of claim 4, wherein the second leakage boosting core is located outside an outer diameter of the principal core.

6. The inductor of claim 1, wherein the leakage boosting core is located outside an outer diameter of the principal core.

7. The inductor of claim 1, wherein the leakage boosting core is located axially in-line with the principal core.

8. The inductor of claim 1, wherein the leakage boosting core is a single part located both axially in-line and outside an outer diameter of the principal core.

9. The inductor of claim 1, wherein the leakage boosting core is a single part located both axially in-line and inside an inner diameter of the principal core.

10. (canceled)

11. The inductor of claim 1, wherein the leakage boosting core is composed of high permeability magnetic material.

12. A circuit comprising:
a power converter; and
a common mode inductor coupled to the power converter, the common mode inductor comprising a principal core and a leakage boosting core separate from the principal core and located within a threshold distance of the principal core, wherein the threshold distance is selected to control a leakage flux of the inductor.

13. The circuit of claim 12, wherein the inductor is coupled to an incoming power input of the circuit, and wherein the inductor provides power to an input of the power converter.

14. The circuit of claim 13, further comprising:
a second common mode inductor coupled to the power converter, the second common mode inductor comprising a second principal core and a second leakage boosting core located within a second threshold distance of the second principal core wherein the second threshold distance is selected to control a leakage flux of the second inductor.

15. The circuit of claim 14, wherein the second inductor receives power from the power converter and provides power to an outgoing power output of the circuit.

16. The circuit of claim 12, wherein the inductor receives power from the power converter and provides power to an outgoing power output of the circuit.

17. The circuit of claim 12, wherein the power converter comprises a switching power converter.

18. A method for reducing the use of differential mode inductors in a power converter circuit, comprising:
constructing a common mode inductor comprising a principal core and a leakage boosting core located within a threshold distance of the principal core; and
causing the inductor to be coupled to at least one of an input of a power converter and an output of the power converter.

19. The method of claim 18, further comprising:
selecting an air gap width between the principal core and the leakage boosting core in order to control an amount of leakage inductance in the inductor,
wherein the construction of the inductor is based on the selected air gap width.

20. The method of claim 18, wherein the construction of the inductor comprises placing a plurality of windings about the principal core.
